(19) United States
(12) Patent Application Publication
(10) Pub. No.: US 2019/0057100 A1
(43) Pub. Date: Feb. 21, 2019

(54) PROCESSING DATA RECORDS USING CAPABILITIES AND HANDLES

(71) Applicant: salesforce.com, inc., San Francisco, CA (US)

(72) Inventors: Matthew Burghoffer, Menlo Park, CA (US); Robert M. Van Osten, San Jose, CA (US); Sean Patrick Lynch, Redwood City, CA (US); Adam Evans, Redwood City, CA (US)

(21) Appl. No.: 15/677,762

(22) Filed: Aug. 15, 2017

(51) Int. Cl. G06F 17/30

(52) U.S. Cl. CPC G06F 17/30076; G06F 17/30106

(57) ABSTRACT

A method accesses, by a processing device executing with relation to a data pipeline, first data of a first data type and identifies a first field within the first data that is classified with a first capability, wherein a capability includes a prospective treatment of the first data that is independent of the first data type. The method accesses second data of a second data type and identifies a second field within the second data that is also classified with the first capability. The method executes processing logic on a combination of the first data within the first field and the second data within the second field in a way consistent with the first capability. The method generates a data file as an output from execution of the processing logic, the data file being independent from the first data and the second data.

### COPYRIGHT NOTICE

Portions of the disclosure of this patent document may contain material subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate generally to data pipelines processing of data records and, more particularly, to providing additional layers of characterization to fields of data flowing through the data pipelines for joint processing purposes.

### BACKGROUND

Currently, when writing data processing pipelines, it is most common for programmers to write modules for extracting or enriching data, and manually linking those together, but this is time consuming. For example, data flowing through the data pipeline is usually classified with a data type. Merely knowing the data type, however, is not always sufficient to understand how data fields at different granularities should be treated, and thus programmers are left with writing separate modules and manually linking those modules in order to combine certain fields of data in a helpful way.

### BRIEF DESCRIPTION OF THE DRAWINGS

The included drawings are for illustrative purposes and serve to provide examples of possible structures and operations for disclosed systems, apparatus, methods and computer-readable storage media. These drawings in no way limit any changes in form and detail that may be made by one skilled in the art without departing from the spirit and scope of the disclosed implementations.

FIG. 1A is a block diagram illustrating an example environment in which an on-demand database service may be used according to some implementations.

FIG. 1B is a block diagram illustrating example implementations of elements of FIG. 1A and example interconnections between these elements according to some implementations.

FIG. 2 is a block diagram of a data pipeline, according to some implementations.

FIG. 3A is a block diagram of an email message (source data) classified according to handle and capability for use in generating an enriched email message, according to some implementations.

FIG. 3B is a block diagram of a meeting event (source data) classified according to handle and capability for use in generating an enriched meeting invitation, according to some implementations.

FIG. 4 is a block diagram of a set of extractors for extracting a predetermined type of information from each of two different sources of data, such as the enriched email message (FIG. 3A) and enriched meeting invitation (FIG. 3B), according to various implementations.

FIG. 5 is a block diagram of a system containing a matcher that matches a data source (such as an email message) with other stored information in the data pipeline, to generate an opportunity, such as a sales lead, or some other resultant object according to various implementations.

FIG. 6 is a flow diagram illustrating a method for characterization of fields of data records from different data types for similar processing, according to some implementations.

FIG. 7 is a flow diagram illustrating a method for linking data from an external source to field data of a database record based handle characterization, according to some implementations.

FIG. 8 is a flow diagram illustrating a method for ordering execution of extractors when operating on capability-classified fields during flow processing of a data pipeline.

FIG. 9 is a block diagram illustrating an exemplary computer system, according to an implementation.

### DETAILED DESCRIPTION

Examples of systems, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The implementations described herein are directed at additional field classifications within data records that programmers may apply to create modules that classify their dependencies, e.g., as predetermined global declarations, rather than explicitly programming such dependencies. These declarations may be performed by classifying types on the data flowing through a data pipeline, and through classifying the intent of each field of a database record through capability and handle annotations.

A capability may define prospective treatment of the underlying data of the field that is independent of the data type of that field. The capabilities may facilitate the data pipeline (or coupled system) in finding an order in which data extractors may run to enrich the data running through the data pipeline. More specifically, the order in which the extractors are executed may be determined by which extractor needs which capability or a dependence on a prior processing of a certain capability. For example, if a second extractor needs the output of a first extractor, and the first extractor operates on a first capability, then the first extractor should be run first, followed by execution of the second extractor on the output of the first extractor (or on a data record after incorporation of the output data into one of its fields).

An extractor may be employed to extract textual information (e.g., via natural language processing or other code that analyzes text) of any field in a data record classified with a “body” capability, or a body-like capability, such as a date or future date, which can also be expressed with text, as will be discussed in more detail. Different extractors may contain or be programmed with different natural processing algorithms in order to extract predetermined type of information within the text of the field data being processed. The extractors may also include regular expressions, pattern matching, or machine-learned models.

A handle may describe how an underlying field relates to external data, e.g., to records located in a networked cloud or to data stored in a different source within the data pipelines than the database of the subject records. The handles may facilitate the data pipeline (or coupled system) in performing a lookup of an external or separate database to find second data that is correlated to the first data of the field in the database record, as will be further explained.

In one implementation, the disclosed system may access, with relation to a data pipeline, first data of a first data type, and identify a first field within the first data that is classified with a first capability. The disclosed system may also access, with relation to the data pipeline, second data of a second data type, and identify a second field within the second data that is also classified with the first capability. The disclosed system may then execute, using a processing device, processing logic on a combination of the first data within the first field and the second data within the second field in a way consistent with the first capability, and thus be able to jointly process data from disparate sources that are classified with the same capability (e.g., “body” capability). The disclosed system may then generate a data file as an output from execution of the processing logic, the data file being independent from the first data and the second data.

In another implementation, the system may access, with execution in relation to a data pipeline, first data of a first data type within a first data record. The system may further identify a first field data within the first data. The system may detect a first handle associated with the first field data. The system may further, in view of a type of the first handle, perform a lookup, within an external database stored in computer memory of the data pipeline, to determine second data corresponding to the first field data. The system may then combine the first field data with the second data into a data file as an output of the data pipeline.

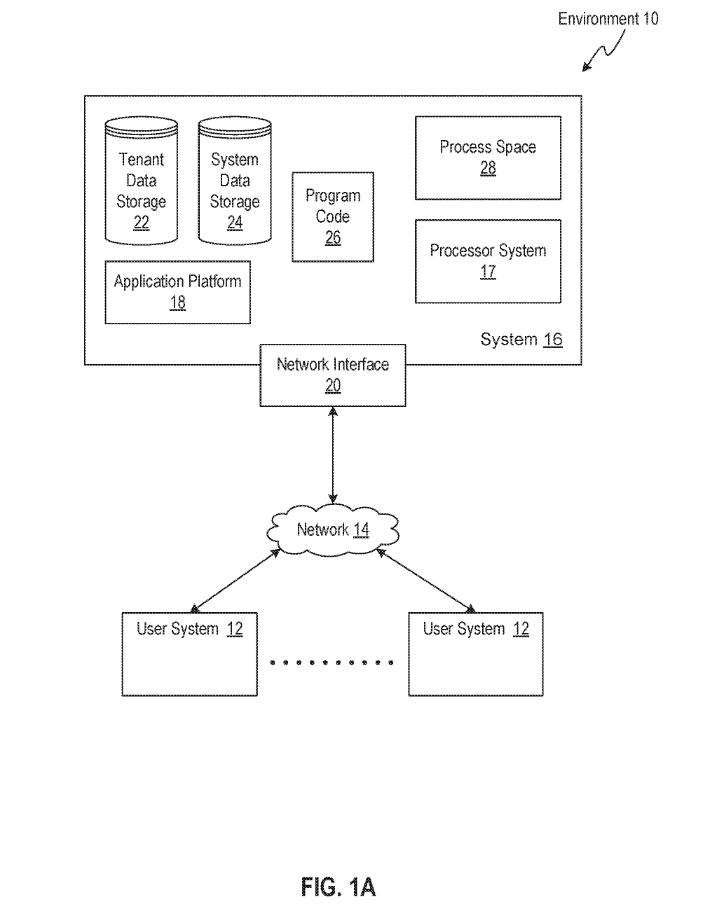

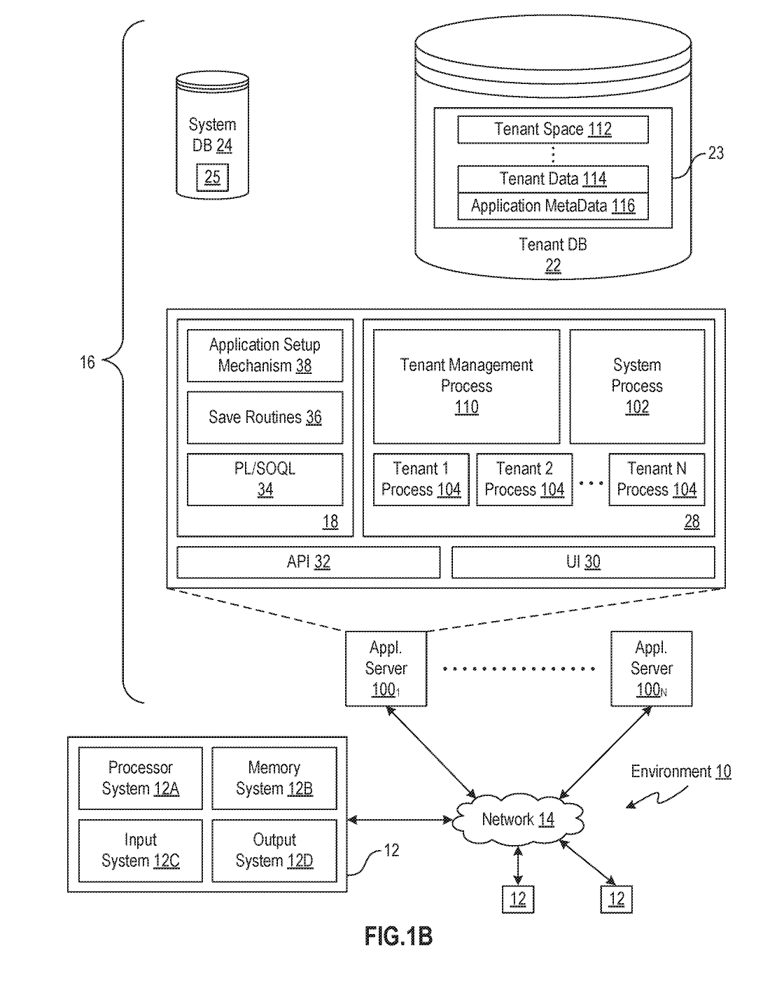

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16, and request those services, e.g., on demand. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

The application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system, related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application, for example, OODBMS or RDBMS. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with the system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a mouse, a keyboard device, a trackball, a touch pad, a touch screen (which may implement a keyboard device in some cases), a pen or stylus or the other mouse-like substitute, for interacting with a graphical user interface (GUI) 30 provided by the browser on a display (for example, a monitor screen, liquid crystal display (LCD), light-emitting diode (LED) display, or other display 31) of the user system 12 in conjunction with pages, forms, applications and other information provided by the system 16 or other systems or servers. Furthermore, the user interface device can be used to access data and applications hosted by system 16, and to perform searches on stored data, and otherwise allow a user to interact with various GUI pages that may be presented to a user, whether executed locally on the user system 12 or remotely on the system 16. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server,” is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using procedural language, Salesforce Object Query Language (PL/SOQL) 34 (or optionally SQL), which provides a programming language style interface extension to application programming interface (API) 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety. Invocations to applications can be detected by one or more system processes, which manage retrieving application metadata 116 for the subscriber making the invocation and executing the metadata as an application in a virtual machine.

The system 16 of FIG. 1B may also include a user interface (UI) 30 and the API 32 to system 16 resident processes available to users or developers at user systems 12. In some other implementations, the environment 10 may not have the same features as those listed above or may have other features instead of, or in addition to, the features listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which the system 16 handles storage of, and access to, different objects, data and applications across disparate users and organizations.

In one example storage use case, one tenant can be a company that employs a sales force where each salesperson uses the system 16 to manage aspects of their sales. A user can maintain contact data, leads data, customer follow-up data, performance data, goals and progress data, etc., all applicable to that user's personal sales process (for example, in the tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems 12. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by the system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to a tenant database 22 or a system database 24. The system 16 (for example, an application server 100 in the system 16) can automatically generate one or more SQL statements (for example, one or more SQL queries) designed to access the desired information. The system database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In some implementations, some of the methods, processes, devices and systems described herein can implement, or be used in the context of, enterprise social networking. Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). As described below, the data can include messages created by other users. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user requests to be subscribed to the group (and be accepted by, for example, an administrator or owner of the group), is invited to subscribe to the group (and accept), or is directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or group of users of the database system 16. Such records can include, for example, data objects representing and maintaining data for accounts, cases, opportunities, leads, files, documents, orders, pricebooks, products, solutions, reports and forecasts, among other possibilities. For example, a record can be for a business partner or potential business partner (for example, a client, vendor, distributor, and the like) of a user or a user's organization, and can include information describing an entire enterprise, subsidiaries of an enterprise, or contacts at the enterprise. As another example, a record can be a project that a user or group of users is/are working on, such as an opportunity (for example, a possible sale) with an existing partner, or a project that the user is trying to obtain. A record has data fields that are defined by the structure of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in the graphical user interface (GUI) 30 on a display device such as the display 31 of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages (with text, email message, posts or the like), files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, and the like, can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a User's Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can be, in some instances, applications, or implementations, desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

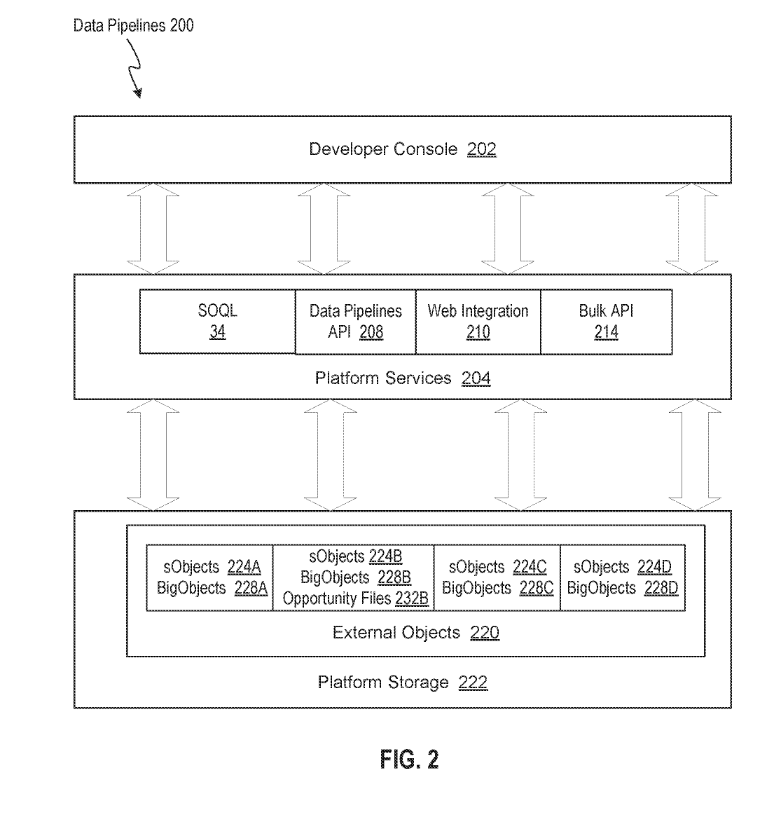

FIG. 2 is a block diagram of data pipelines 200, according to some implementations. The data pipelines 200 are an instantiation of platform-based software services that help developers and administrators manage the challenges of the increasing scale of customer data (e.g., Big Data). The data pipelines 200, for example, allow highly scalable batch processing, transformation, and understanding of customer data, offering a powerful tool set that may express data flow control with a set of functions (and other functionality) to help evaluate the customer data.

In various implementations, the data pipelines 200 may include, but not be limited to, a developer console 202 through which developers may access the disclosed software tools through a platform services layer 204. The platform services layer 204 is coupled to platform storage 222 in which is stored a number of external objects 220 for use to facilitate scalable batch processing, transformation, and analysis of customer data. Accordingly, the developer console 202 makes available to developers and administrators a number of platform services of the platform services layer 204, which in turn use various external objects 220 (or groups of external objects) stored in the platform storage 222.

The platform services layer 204 may deploy tools such as the SOQL 34 (discussed with reference to FIG. 1B), a data pipelines API 208, Web integration 210, and a bulk API 214. The external objects 220 stored in the platform storage 222 may include, but not be limited to, a first group of sObjects 224A and BigObjects 228A, a second group of sObjects 224B, BigObjects 228B, and opportunity files 232B, a third group of sObjects 224C and BigObjects 228C, and a fourth group of sObjects 224D and Big Objects 228D. Additional or fewer external objects may be stored in the platform storage and available to the platform services layer 204. One of the platform services 204 may generate an opportunity file 232, such as a packaged sales lead or other opportunity that may be correlated with a customer, and optionally be trackable with reference to that customer. In other settings, other software packages or objects may be generated other than sales leads and opportunities. Accordingly, reference to sales leads and opportunities herein is by way of example only.

The data pipelines API 208 may provide access to data from various sources, e.g., work with data already on the platform services layer 204, or load data into customer sObjects or BigObjects by using the bulk API 214. With the data pipelines API 208, a developer may process many types of customer data, including sObjects, BigObjects, proprietary files, and the external objects 220. A developer or administrator may store the results in sObjects and BigObjects for use by other APIs and applications, including email applications, calendar applications, contact applications, and the like. With the developer console 202, a developer may write and deploy the data pipelines' jobs that use data from any of these sources. In one implementation, the developer or administrator may work directly with comma separated value (CSV) data in proprietary files, or may insert data into the data pipelines 200 using the bulk API 214. In various implementations, the data pipelines 200 may be controlled with Apache™ Hadoop® and Apache™ Pig, which runs on top of Hadoop®. Accordingly, the data pipelines 200 may be used to create and submit Apache™ Pig jobs with proprietary data in some embodiments (although other Big Data software may also or alternatively be deployed).

The Web integration 210 may include code, logic, software, or a combination of hardware and software, that enables Web services and callouts. The Web services may allow Web-based integration within the data pipelines 200, e.g., such that data records generated or processed by other of the platform services 204 or obtained from the external objects 220, may be provided within a Web page or browser. The Web integration 210 also supports the ability to invoke external Web services, otherwise known as callouts.

More specifically, for Web services, the Web integration 210 supports the ability to write logic and expose the logic as a Web service. An external application can therefore invoke this Web service to perform custom logic. With callouts, where the Web integration 210 invokes an external Web service, the Web integration 210 provides integration with Web services that utilize programming such as Simple Object Access Protocol (SOAP) and Web Services Description Language (WSDL), or hypertext transfer protocol (HTTP) services (e.g., RESTful services), in various implementations. The Web integration 210 supports the importing of WSDLs to auto-generate the corresponding integration classes. Additionally, the Web integration 210 supports HTTP services to use HTTP Request and Response objects to invoke the external web service.

A user defined function (UDF) may be an extension of the Apache™ Pig software language (or other Big Data software language) that is created by a user, e.g., a developer or administrator. The UDFs may allow one to specify custom processing. The UDFs may be written in Java (or other object-oriented code), but may be implemented in Python or JavaScript (or other software code). The UDFs may thus enable customization of processing of data, which may include specification of type of logic to be performed on data of certain type, fields of database records classified with a certain capability and/or handle as will be discussed in more detail. Performing these tasks in the context of the data pipelines 200 allows bulk processing and handling of Big Data in the context of monitoring, extracting, and processing large amounts customer data to generate packaged sales leads, opportunity files associated with such sales leads, or other objects.

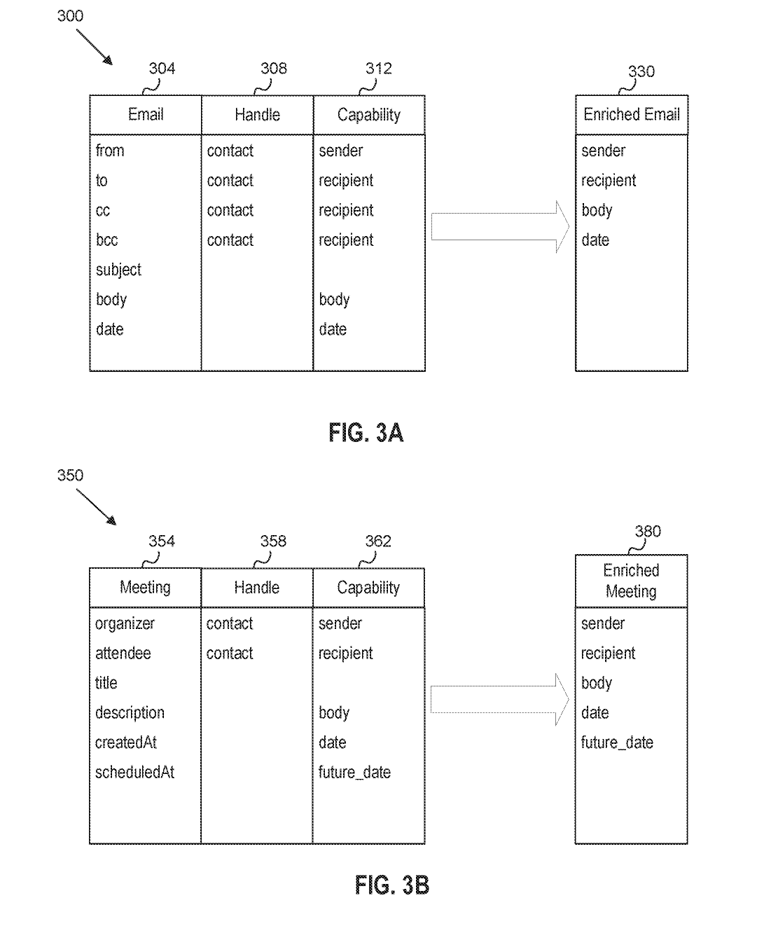

FIG. 3A is a block diagram of an email message 300 (source data) classified according to handle and capability for use in generating an enriched email message 330, according to some implementations. The email message 300 may include a number of linked data fields, including email fields 304, handle fields 308, and capability fields 312. The email fields 304 may include, for example, “from,” “to,” “cc,” “bcc,” “subject,” “body,” and “date” of the email message.

The handle fields 308 may indicate a “contact” handle for each of the following email fields 304: “from,” “to,” “cc,” and “bcc.” A handle may describe how the underlying fields (e.g., the email fields 304) related to external data such as any of the external objects 220 of the data pipelines 200 (FIG. 2) or data in a networked cloud or separate database, which is independent of data type. In this case, each of the identified fields is a “contact,” which means that the individuals in these fields may be looked up as a contributor to (or owner of) an opportunity or deal in a contacts database. A handle of “company,” furthermore, may be used to look up an account in an accounts or customer database. Other handles may include a “zip code” (for city look up) or certain types of diagnosis information, for example.

The capability fields 312 may characterize prospective treatment (e.g., how to jointly process) data in underlying fields. Accordingly, in the depicted example, the “from” email field may be classified as a “sender” capability (e.g., capable of sending emails) and the “to,” “cc,” and “bcc” fields may be classified as a “recipient” capability (e.g., capable of receiving emails). Furthermore, the “body” may be classified as “body” capability (e.g., contains body text) and the “date” field may be classified with “date” capability (e.g., contains a date formatted in some way). Another capability may be a location, such as latitude and longitude, which may be associated with social media or the location a picture was taken, or the like. Still another capability may be a “summary,” with reference to a subject line in an email or a calendar invitation. Additional or different capabilities may be employed, as discussed herein.

In some implementations, the platform services layer 204 (or other component of the data pipelines 200), may then be able to generate the enriched email message 330 (which may be a sales lead or other opportunity), which includes at least some of the capability fields 312. In the depicted example, the enriched email message 330 may include data from the fields with sender capability, recipient capability, body capability, and date capability, to generate the sales lead or opportunity. Use of data from different or additional capability fields is envisioned.

If necessary to complete an actual draft email message, the platform services layer 204 may look up the individual email address of any of the sender or recipient in order to populate these fields in the enriched email message 330. This may need to happen when the email message 300 is a database record or plain text copy and may have lost the actual email address portion of the “to” field (e.g., merely retains a person's name). Because these fields have been classified with a “contact” handle, the platform services layer 204 may perform a look up in an organization's “contacts” to determine an email address for the people listed in the “from” and “to” fields. The enriched email message 330 may then be provided as a draft or sent to the recipient, on behalf of the sender, to provide the sales lead or opportunity (or other notification). In one implementation, the enriched email message 330 is sent to the recipient in response to a query or request received from the recipient.

In one implementation, source data (e.g., email messages) may be formatted along the lines of the following:

@capability (“recipients”)
@handle(“contacts”)
EmailAddress[ ] to;
@capability (“recipients”)
@handle(“contacts”)
EmailAddress[ ] cc;
@capability (“recipients”)
@handle(“contacts”)
EmailAddress[ ] bcc;
@capability(“subject”)
string subject;
@capability(“body”)
Body[ ] body;
}record Email {
@capability(“time”)
DateTime date;
@capability(“sender”)
@handle(“contact”)
EmailAddress from;
@capability(“recipients”)
@handle(“contact”)
EmailAddress [ ] to;
@capability(“recipients”)
@handle(“contact”)
EmailAddress [ ] cc;
@capability(“recipients”)
@handle(“contact”)
EmailAddress [ ] bcc;
@capability(“subject”);
string subject;
@capability(“body”)
Body [ ] body;
}

FIG. 3B is a block diagram of a meeting event 350 (e.g., calendar event) classified according to handle and capability for use in generating an enriched meeting invitation 380, according to some implementations. The meeting event 350 may include a number of linked data fields, including meeting fields 354, handle fields 358, and capability fields 362. The meeting fields 354 may include, by way of example, “organizer,” “attendee,” “title,” “description,” “created at,” and “scheduled at.” In various embodiments, the handle fields 358 may include a handle of “contact” for the “organizer” and “attendee” fields, meaning that the platform services layer 204 may look up the organizer and attendee in an external database, e.g., as one of the external objects 220 (FIG. 2) or in a cloud.

In various embodiments, the capability fields 312 may characterize prospective treatment (e.g., how to jointly process) data in underlying fields. Accordingly, in the depicted example, the “organizer” field may be classified with “sender” capability (e.g., capable of sending meeting invitations) and the “attendee” field may be classified with “recipient” capability (e.g., capable of receiving meeting invitations). Furthermore, the “description” field may be classified with “body” capability, the “created at” field classified with “date” capability, and the “scheduled at” field classified with “future date” capability. The enriched email message 330 may then be provided as a draft or sent to the recipient, on behalf of the sender, to provide the enriched meeting invitation 380 to the recipient to add to the recipient's calendar. In one implementation, the enriched meeting invitation 380 is sent to the recipient in response to a query or request received from the recipient.

In some implementations, the platform services layer 204 (or other component of the data pipelines 200), may then be able to generate the enriched meeting invitation 380 (which may be a sales meeting or the like), which includes at least some of the capability fields 362. In the depicted example, the enriched meeting invitation 380 may include data from the fields classified with sender capability, recipient capability, body capability, date capability, and future date capability. If necessary, the platform services layer 204 may search the external objects 220 to determine an email address (or instant messaging address or the like) associated with the organizer and the attendee (e.g., where the meeting fields 354 for organizer and attendee are plain text and void of email or message portion).

In one implementation, source data (e.g., calendar events) may be formatted along the lines of the following:

@capability(“recipients”)
@handle(“contact”)
string attendees;
@capability(“subject”)
string title;
@capability(“body”)
String description;
}record Calendar {

@capability(“sender”)
@handle(“contact”)
string organizer;
@capability(“recipients”)
@capability(“contact”)
string attendees;
@capability(“subject”)
string title;
@capability(“body”)
string description;

}

Note that even though the disclosed underlying data fields are different, and even though the data types of each similar field is different, the underlying data fields may be annotated with the same “capability.” For example, the “body” of an email message may be considered to have “body” capability; the “description” field of a calendar event may also have “body” capability, and so may be processed through any extractor that operates on bodies of text (e.g., sentiment analysis, signature parsing, mentioning a competitor, and many more possible extractors).

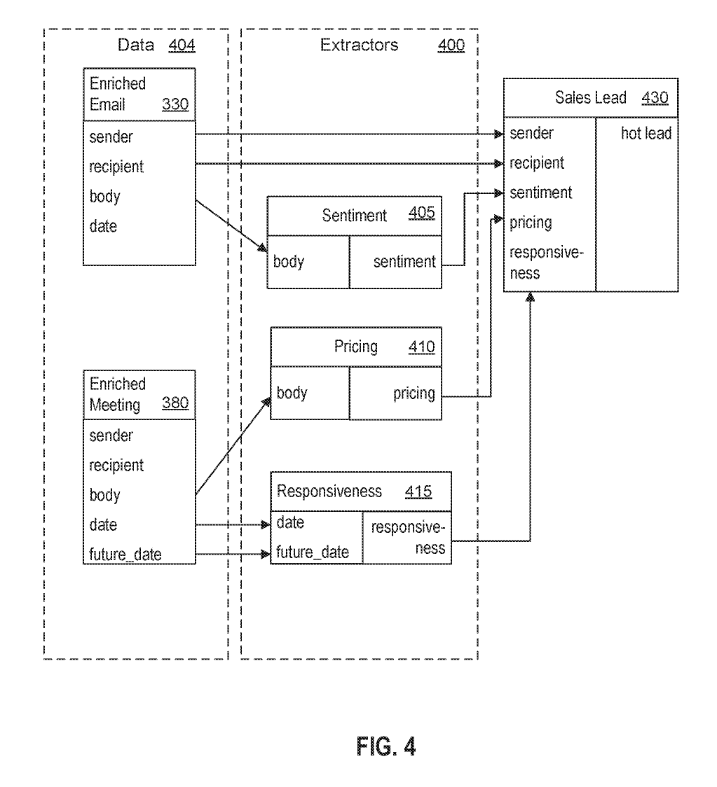

FIG. 4 is a block diagram of a set of extractors 400 for extracting a predetermined type of information from each of two different sources of data, such as the enriched email message 330 (FIG. 3A) and a enriched meeting invitation 380 (FIG. 3B), according to various implementations, although other data sources may also be used (such as instant message, text message, transcribed voice mail, and the like). An extractor may take, as input, any record that has a field with a “body” capability or a body-like capability (in containing text), regardless of record type (e.g., the data type of the data in that field). The extractor may extract certain predetermined information from data of the field with such capabilities.

The set of extractors 400, in one implementation, may include a sentiment extractor 405, a pricing extractor 410, and a responsiveness extractor 415. The extracted data may be combined into a sales lead 430 (or some other opportunity or object). In one example, the data for the sender and recipient in the enriched email message 330 may be transferred over to the sales lead 430. The extractors may be employed to obtain the sentiment and pricing data, which are to be inserted into a single data structure such as the sales lead 430, which may be stored in relation to the sender, the recipient, the email address of the recipient or other customer, or indexed according to such information within a database of hot leads.

More specifically, the sentiment extractor 405 may extract a sentiment (e.g., feeling-related language) from the text of the “body” field of the enriched email message 330. For example, in one implementation, the sentiment extractor 405 may be expressed as: “Function getSentiment (@capability(“body”) body): Score.” The pricing extractor 410 may extract pricing-related information from text of the “body” field of the new meeting invitation 360. The responsiveness extractor 415 may extract text classified as a date (e.g., current date) and text classified as a “future date” from corresponding body capability fields of the enriched meeting invitation 380. The date may be the current date while the future date may be a future date to which the customer has delayed a meeting. Accordingly, the date and the future date may together be indicative of a level of responsiveness of the customer, which the responsiveness extractor 415 may determine, e.g., as a responsiveness metric (such as number of days or hours of delay).

In various implementations, the sentiment text, pricing information, and responsiveness information may also be included in the sales lead 430, which may be a sales-related object to be stored or to be sent as a communication to the recipient (e.g., as an email message, instant message, meeting invitation, or the like). In one implementation, the responsiveness-related information may be stored as metadata with or in relation to the sales lead 430.

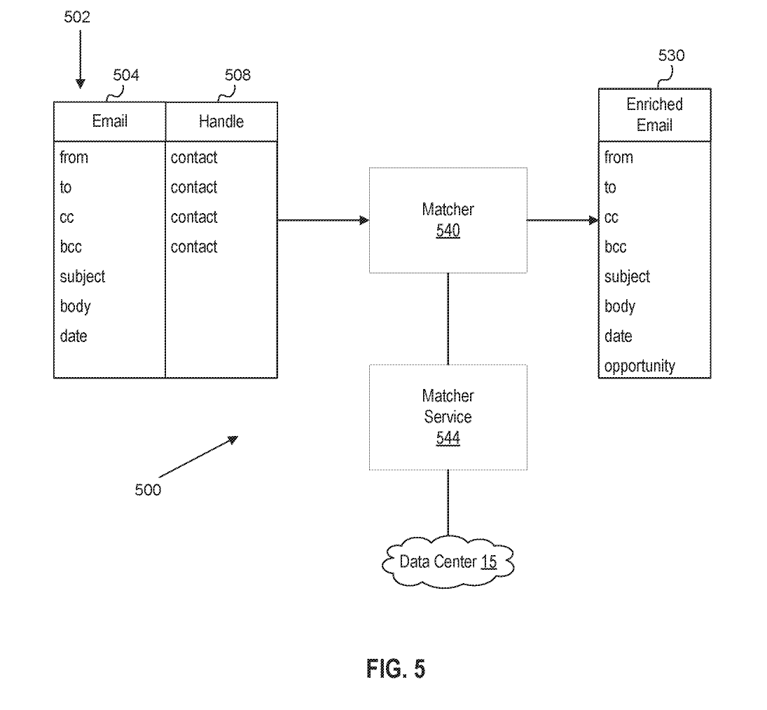

FIG. 5 is a block diagram of system 500 containing a matcher 540 that matches a data source (such as an email message 502) with other stored information in the data pipeline, to generate an opportunity, such as a sales lead, or some other resultant object according to various implementations. The term opportunity may denote a contact or customer that is qualified in certain ways to be targeted. Other customer-related or software objects may be generated in lieu of a sales lead or opportunity. The system 500 may further include a matcher service 544 and data center 15, which in one implementation, houses the data pipelines 200.

In various implementations, the matcher 540 may include an extractor to extract data from multiple email fields 504, which are linked to a handle 508, e.g., a “contact” handle in the displayed implementation. The matcher 540 may execute a piece of code that calls another service, e.g., the matcher service 544, which analyzes the content of the email message 502, and determines a sales opportunity (or other connected piece of information) with which it is most likely associated. In one implementation, the sales opportunities are stored according to identifiers within a data center 15, which may include the platform storage 222 of the data pipelines 200 (FIG. 2).

After calling the matcher service 544 to determine this information, the matcher 540 may enrich the email message 502 to add the sales opportunity (or other database object), e.g., an identifier associated with the sales opportunity, to generate an enriched email message 530. The enriched email message 530 may then be provided to a client or administrator as a customer or sales lead. Any opportunity (or other database object) may also be stored next to email addresses (or other contact information) of the customer to which the opportunity (or database object) relates. In one implementation, email addresses within a stored opportunity may also be associated with the stored email addresses with which the opportunity is stored (e.g., within the data center 15 or platform storage 222).

Accordingly, programmers, through the developer console 202, can now independently program data sources that declare (or classify) a logical intent by way of capabilities and handles in addition to existing data type classifications. The programmers may also create modules that declare what capabilities or handles they can utilize to run. Additionally, extractors are also able to enrich the data stream with new capabilities so other extractors can utilize programmatically-generated capabilities. With a library of available sources (such as email messages, meeting invitations, instant messages, social media posts, and the like), extractors, and sinks (such a data warehouse, a message queue, web hook or the like), the data pipelines 200 may create complicated and type-safe data flows using only capability and handle classifications.

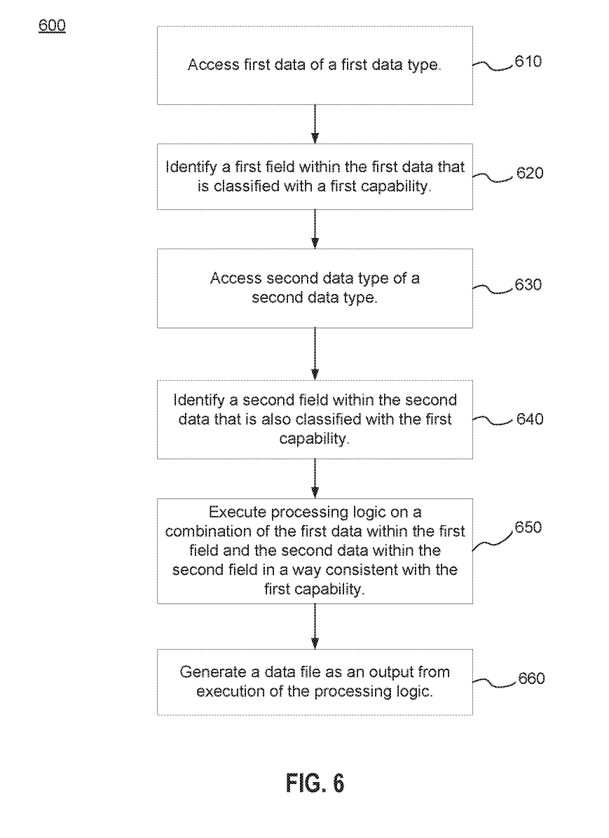

FIG. 6 is a flow diagram illustrating a method for characterization of fields of data records from different data types for similar processing, according to some implementations. The method 600 may be performed by processing logic that comprises hardware (e.g., circuitry, dedicated logic, programmable logic, microcode, etc.), software (e.g., instructions run on a processor to perform hardware simulation), firmware, or a combination thereof. The processing logic may be configured to process data classified with the same capability type. In one implementation, the method 600 may be performed by a user system 12 or a system 16, as shown in FIGS. 1A and 1B, or a data pipeline 200 as shown in FIG. 2.

With further reference to FIG. 6, the method 600 may begin with the computer system accessing, by a processing device executing with relation to the data pipeline 200, first data of a first data type (610). The method 600 may continue with the processing device identifying a first field within the first data that is classified with a first capability (620). A capability may make reference to a prospective treatment of the first data that is independent of the first data type. The method 600 may continue with the processing device accessing second data of a second data type in execution with reference to the data pipeline (630). The method 600 may continue with the processing device identifying a second field within the second data that is also classified with the first capability (640). The method 600 may continue with the processing device executing processing logic on a combination of the first data within the first field and the second data within the second field in a way consistent with the first capability (650). The method 600 may continue with the processing device generating a data file as an output from execution of the processing logic, the data file being independent from the first data and the second data (660).

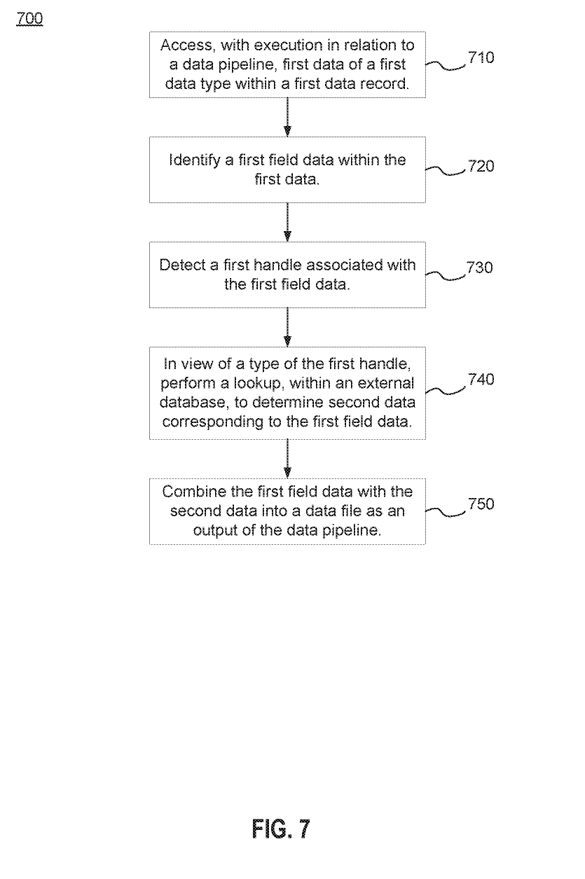

FIG. 7 is a flow diagram illustrating a method for linking data from an external source to field data of a database record based handle characterization, according to some implementations. The method 700 may be performed by processing logic that comprises hardware (e.g., circuitry, dedicated logic, programmable logic, microcode, etc.), software (e.g., instructions run on a processor to perform hardware simulation), firmware, or a combination thereof. The processing logic may be configured to process data classified with the same capability type or to look up external data objects with handle classification information. In one implementation, the method 700 may be performed by a user system 12 or a system 16, as shown in FIGS. 1A and 1B, or a data pipeline 200 as shown in FIG. 2.

With further reference to FIG. 7, the method 700 may begin with the computer system accessing, with a processing device executing in relation to the data pipeline 200, first data of a first data type within a first data record (710). The method 700 may continue with the processing device identifying a first field data within the first data (720). The method 700 may continue with detecting a first handle associated with the first field data (730). The method 700 may continue with, in view of a type of the first handle, the processing device performing a lookup, within an external database stored in a computer memory of the data pipeline 200, to determine second data corresponding to the first field data (740). The method 700 may continue with the processing device combining the first field data with the second data into a data file as an output of the data pipeline (750).

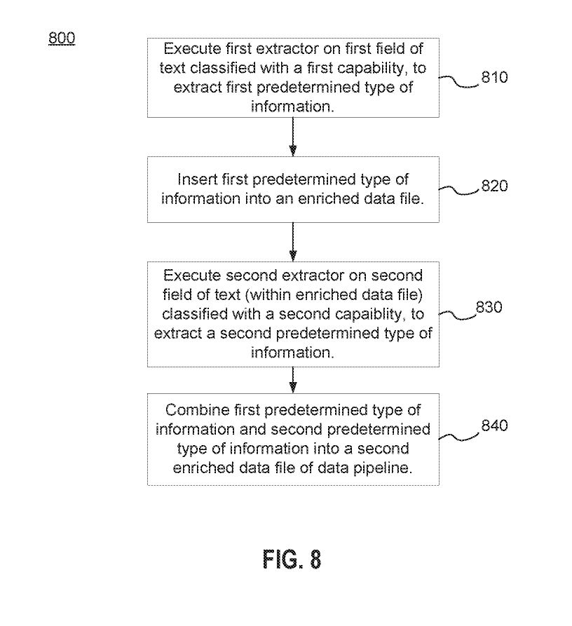

FIG. 8 is a flow diagram illustrating a method 800 for ordering execution of extractors when operating on capability-classified fields during flow processing of a data pipeline. The method 800 may be performed by processing logic that comprises hardware (e.g., circuitry, dedicated logic, programmable logic, microcode, etc.), software (e.g., instructions run on a processor to perform hardware simulation), firmware, or a combination thereof. The processing logic may be configured to process data classified with the same capability type or to look up external data objects with handle classification information. In one implementation, the method 800 may be performed by a user system 12 or a system 16, as shown in FIGS. 1A and 1B, or a data pipeline 200 as shown in FIG. 2.

With further reference to FIG. 8, the method 800 may begin with the computer system executing a first extractor to operate on a data record containing a first field of text classified with a first capability, the first extractor to extract a first predetermined type of information from the first field of text (810). The method 800 may continue with the computer system inserting the first predetermined type of information into an enriched data file (820). The method 800 may continue with the computer system executing a second extractor to operate on the enriched data file, the second extractor to extract a second predetermined type of information from a second field of text of the enriched data file, wherein the second field of text is classified with a second capability (830). The method 800 may continue with the computer system combining the first predetermined type of information with the second predetermined type of information into a second enriched data file as an output of the data pipeline (e.g., a communication file containing a sales lead, an opportunity, or other data object) (840).

It should be noted that the sequence of operations described in conjunction with methods 600, 700, 800 may be different from that illustrated, respectively, in corresponding FIGS. 6, 7, and 8 unless otherwise explicitly required. The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, e.g., ORACLE®, DB2® by IBM, and the like without departing from the scope of the implementations claimed. Moreover, the implementations are applicable to other systems and environments including, but not limited to, client-server models, mobile technology and devices, wearable devices, and on-demand services.

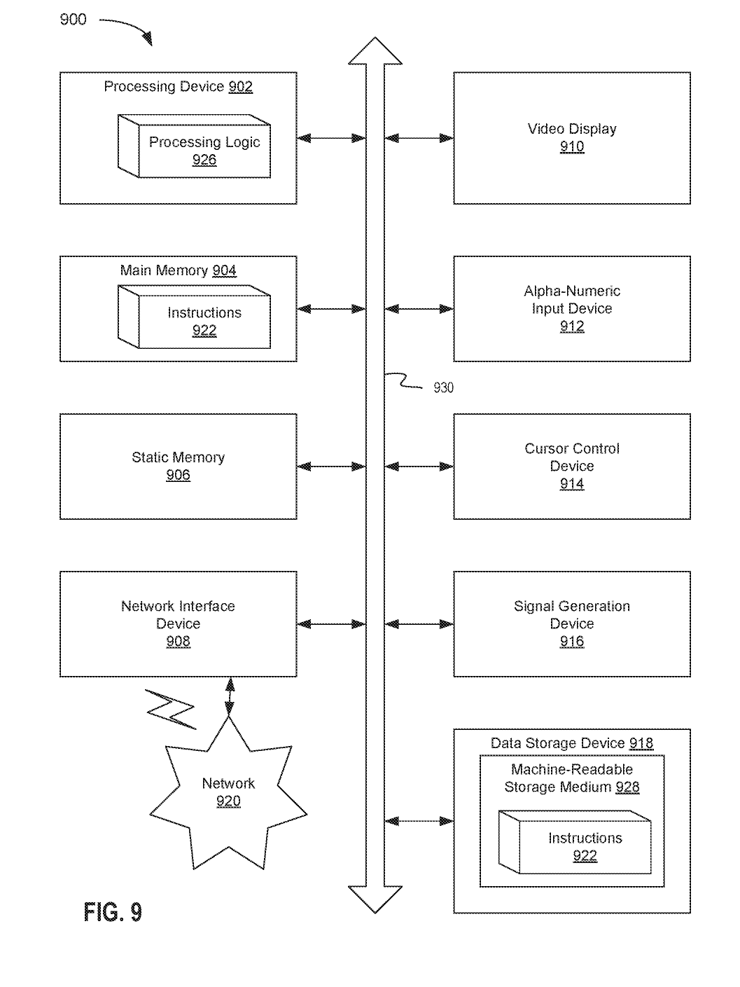

FIG. 9 illustrates a diagrammatic representation of a machine in the exemplary form of a computer system 900 within which a set of instructions, for causing the machine to perform any one or more of the methodologies discussed herein, may be executed. The system 900 may be in the form of a computer system within which a set of instructions, for causing the machine to perform any one or more of the methodologies discussed herein, may be executed. In alternative implementations, the machine may be connected (e.g., networked) to other machines in a local area network (LAN), an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one implementation, for example, computer system 900 may represent the system 16, as shown in FIGS. 1A and 1B, or aspects the data pipelines 200 of FIG. 2.

The exemplary computer system 900 includes a processing device (processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)), and a data storage device 918, which communicate with each other via a bus 930. The processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute the notification manager 210 for performing the operations and steps discussed herein.

The computer system 900 may further include a network interface device 908. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

The data storage device 918 may include a computer-readable medium 928 on which is stored one or more sets of instructions 922 (e.g., instructions of in-memory buffer service 114) embodying any one or more of the methodologies or functions described herein. The instructions 922 may also reside, completely or at least partially, within the main memory 904 and/or within processing logic 926 of the processing device 902 during execution thereof by the computer system 900, the main memory 904 and the processing device 902 also constituting computer-readable media. The instructions may further be transmitted or received over a network 920 via the network interface device 908.

While the computer-readable storage medium 928 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining;” “identifying;” “adding;” “selecting;” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
accessing, by a processing device executing with relation to a data pipeline, first data of a first data type;
identifying a first field within the first data that is classified with a first capability, wherein a capability comprises a prospective treatment of the first data that is independent of the first data type;
accessing, by the processing device executing with relation to the data pipeline, second data of a second data type;
identifying a second field within the second data that is also classified with the first capability;
executing, by the processing device, processing logic on a combination of the first data within the first field and the second data within the second field in a way consistent with the first capability; and
generating, by the processing device, a data file as an output from execution of the processing logic, the data file being independent from the first data and the second data.

2. The method of claim 1, wherein the first data is from a different source of data than the second data.

3. The method of claim 1, wherein the first capability is a body capability, further comprising executing, by the processing device:
a first body extractor to extract the first data from the first field; and
a second body extractor to extract the second data from the second field.

4. The method of claim 1, wherein the first field is associated with a first handle, the first handle comprising an association with a database record that is stored in an external database of a computer memory of the data pipeline.

5. The method of claim 1, wherein the first data is from an email, the second data is from a scheduled meeting, and wherein the data file comprises a communication file containing a sales lead.

6. The method of claim 1, wherein the first data is from an email, the second data is from an instant message, and wherein the data file comprises a packaged sales lead.

7. A system comprising:
a data pipeline to process data records and to generate and transmit each of a plurality of communication files containing data from respective data records;
a processing device coupled to the data pipeline, wherein the processing device is to:
execute a first extractor to operate on a first record containing a first field of text classified with a body capability, the first extractor to extract a predetermined type of information from the first field of text, wherein a capability comprises a prospective treatment of the first field of text that is independent of a data type of the first field of text; and
combine the predetermined type of information with additional data, related to the predetermined type of information, into a data file as an output of the data pipeline.

8. The system of claim 7, wherein the first record is an email, the first field of text comprises one of a description or a body, and the predetermined type of information comprises sentiment-related text.

9. The system of claim 7, wherein the processing device is further to:
execute a second extractor to operate on a second record containing a second field of text classified as a body capability, the second extractor to extract a second predetermined type of information from the second field of text; and
combine the second predetermined type of information with the first predetermined type of information into the data file.

10. The system of claim 9, wherein the second record is a meeting, the second field of text comprises one of a description or a body, and the second predetermined type of information comprises pricing-related text.

11. The system of claim 10, wherein the first record is an email, the predetermined type of information comprises sentiment-related text, and wherein the processing device is further to combine the pricing-related text with the sentiment-related text, and with sender and recipient information from the email, to generate the data file as a sales lead.

12. The system of claim 9, wherein the second field of text comprises a meeting and the second predetermined type of information comprises one of responsiveness-related text or a prospective scheduling date.

13. The system of claim 7, wherein the first field of text is associated with a first handle, and wherein the processing device is further to:
detect the first handle as associated with the first body of text; and
perform a lookup of external data in a coupled computer memory, the external data related to information within the first field of the text.

14. A non-transitory computer-readable medium storing instructions, which when executed by a processing device in relation to databases of a data pipeline, cause the processing device to:
execute a first extractor to operate on a data record containing a first field of text classified with a first capability, the first extractor to extract a first predetermined type of information from the first field of text, wherein a capability comprises a prospective treatment of the first field of text that is independent of a data type of the first field of text;
insert the first predetermined type of information into an enriched data file;
execute a second extractor to operate on the enriched data file, the second extractor to extract a second predetermined type of information from a second field of text of the enriched data file, wherein the second field of text is classified with a second capability; and
combine the first predetermined type of information with the second predetermined type of information into a second enriched data file as an output of the data pipeline.

15. The non-transitory computer-readable medium of claim 14, wherein the data record comprises a meeting invitation, the first predetermined type of information comprises a body of the meeting invitation, and wherein the enriched data file comprises an enriched meeting invitation containing a created-at date and scheduled-at date.

16. The non-transitory computer-readable medium of claim 15, wherein the second capability is one of a date capability for the created-at date or a future date capability for the scheduled-at date, and the second predetermined type of information is a responsiveness metric.

17. The non-transitory computer-readable medium of claim 15, wherein the second extractor comprises a responsiveness extractor, the second predetermined type of information comprises the created-at date and the scheduled-at date, and wherein the second enriched data file is a communication file containing a sales lead.

18. A non-transitory computer-readable medium storing instructions, which when executed by a processing device in relation to databases of a data pipeline, cause the processing device to:
access, with execution in relation to a data pipeline, first data of a first data type within a first data record;
identify a first field data within the first data;
detect a first handle associated with the first field data;
in view of a type of the first handle, perform a lookup, within an external database stored in a computer memory of the data pipeline, to determine second data corresponding to the first field data; and
combine the first field data with the second data into a data file as an output of the data pipeline.

19. The non-transitory computer-readable medium of claim 18, wherein the first data record is an email, the first field data comprises a zip code, and the second data comprises a city corresponding to the zip code.

20. The non-transitory computer-readable medium of claim 18, wherein the instructions further cause the processing device to:
access, with execution in relation to the data pipeline, third data of a second data type within a second data record;
identifying a second field data within the third data that is classified with a first capability, wherein a capability comprises a prospective treatment of the second field data that is independent of the second data type;
execute processing logic on a combination of the first field data and the third field data in a way consistent with the first capability; and
generate the data file as a second output from execution of the processing logic, the data file being independent from the first data record and the second data record.
